(19) United States
(12) Patent Application Publication
(10) Pub. No.: US 2008/0085033 A1
(43) Pub. Date: Apr. 10, 2008

(54) Determining orientation through the use of retroreflective substrates

(76) Inventors: Richard E. Haven, Sunnyvale, CA (US); Julie E. Fouquet, Portola Valley, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/543,380

(22) Filed: Oct. 4, 2006

(51) Int. Cl. G06K 9/00; G06K 9/36

(52) U.S. Cl. 382/103; 382/287; 382/151

(57) ABSTRACT

In accordance with the invention, an orientation system includes a target object that includes a retroreflective substrate. Furthermore, the orientation system also includes an illumination source for outputting illumination. Moreover, the orientation system includes a sensor for receiving and for utilizing the illumination retroreflected from the retroreflective substrate of the target object to determine an orientation of the target object.

### BACKGROUND

It is often desirable to be able to input orientation information for gaming, design, and scientific applications. Typically, in these types of environments, it would be desirable to hold an object and be able to track its position and orientation. This can be accomplished through a variety of conventional techniques. For example, one conventional technique for tracking an object's position and orientation is to utilize one or more gyroscopes. Another conventional technique for tracking an object's position and orientation is to utilize stereo vision. Yet another conventional technique for tracking an object's position and orientation is to utilize Micro-Electro-Mechanical Systems (MEMs) accelerators that measure the acceleration of the object.

### SUMMARY

In accordance with the invention, an orientation system includes a target object that includes a retroreflective substrate. Furthermore, the orientation system also includes an illumination source for outputting illumination. Moreover, the orientation system includes a sensor for receiving and for utilizing the illumination retroreflected from the retroreflective substrates of the target object to determine an orientation of the target object.

### BRIEF DESCRIPTION OF THE DRAWINGS

FIG. 1 is a block diagram of an exemplary orientation system in accordance with the invention.

FIG. 2A is a side sectional view of exemplary retroreflectors implemented with a target object in accordance with the invention.

FIG. 2B is another side sectional view of exemplary retroreflectors implemented with a target object in accordance with the invention.

FIG. 2C is yet another side sectional view of exemplary retroreflectors implemented with a target object in accordance with the invention.

FIG. 2D is still another side sectional view of an exemplary retroreflector implemented with a target object in accordance with the invention.

FIG. 2E is yet another side sectional view of exemplary retroreflectors implemented with a target object in accordance with the invention.

FIG. 3 is a diagram showing an exemplary continuous retroreflector band when viewed at different angles in accordance with the invention.

FIG. 4 is a diagram showing two exemplary continuous retroreflector bands that can be utilized for determining three-dimensional orientation in accordance with the invention.

FIG. 5 is a block diagram of another exemplary orientation system in accordance with the invention.

FIG. 6 is a flow diagram of an exemplary method in accordance with the invention.

FIG. 7 is a flow diagram of another exemplary method in accordance with the invention.

FIG. 8 is a block diagram of another exemplary orientation system in accordance with the invention.

FIG. 9 is a block diagram of an exemplary filter in accordance with the invention.

FIG. 10A is a cross-sectional diagram illustrating an exemplary sensor in accordance with the invention.

FIG. 10B is a cross-sectional diagram illustrating another exemplary sensor in accordance with the invention.

FIG. 10C is a cross-sectional diagram illustrating yet another exemplary sensor in accordance with the invention.

FIG. 10D is a cross-sectional diagram illustrating still another exemplary sensor in accordance with the invention.

FIG. 10E is a cross-sectional diagram illustrating another exemplary sensor in accordance with the invention.

FIG. 11 is a graph that depicts exemplary spectra for a filter layer and a narrowband filter for embodiments in accordance with invention.

FIG. 12 illustrates an exemplary Fabry-Perot (FP) resonator used in a method for fabricating a dual-band narrowband filter in accordance with the invention.

FIG. 13 is a graph that depicts exemplary spectrum for a Fabry-Perot resonator in accordance with the invention.

FIG. 14 depicts a coupled-cavity resonator that can be used for fabricating a dual-band narrowband filter in accordance with the invention.

FIG. 15 that depicts exemplary spectrum for a coupled-cavity resonator in accordance with the invention.

FIG. 16 illustrates a stack of three coupled-cavity resonators that form a dual-band narrowband filter in accordance with the invention.

FIG. 17 is a graph that depicts an exemplary spectrum for a dual-band narrowband filter in accordance with the invention.

FIG. 18 is a graph illustrating exemplary filters for embodiments in accordance with the invention.

FIG. 19 is a graph that depicts an exemplary spectrum for a dual-band narrowband filter in accordance with the invention.

### DETAILED DESCRIPTION

Reference will now be made in detail to embodiments in accordance with the invention, examples of which are illustrated in the accompanying drawings. While the invention will be described in conjunction with embodiments in accordance with the invention, it will be understood that these embodiments are not intended to limit the invention. On the contrary, the invention is intended to cover alternatives, modifications and equivalents, which may be included within the scope of the invention as construed according to the Claims. Furthermore, in the following detailed description of embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

It is noted that the invention can include different advantages. For example, at least one embodiment in accordance with the invention can utilize a compact sensor. Also, at least one embodiment in accordance with the invention can utilize just one imager, but is not limited to such. Furthermore, at least one embodiment in accordance with the invention can track long, slow movements of a target object. Additionally, at least one embodiment in accordance with the invention can measure the position of a target object directly. Moreover, no power is required at a target object being tracked, in at least one embodiment in accordance with the invention.

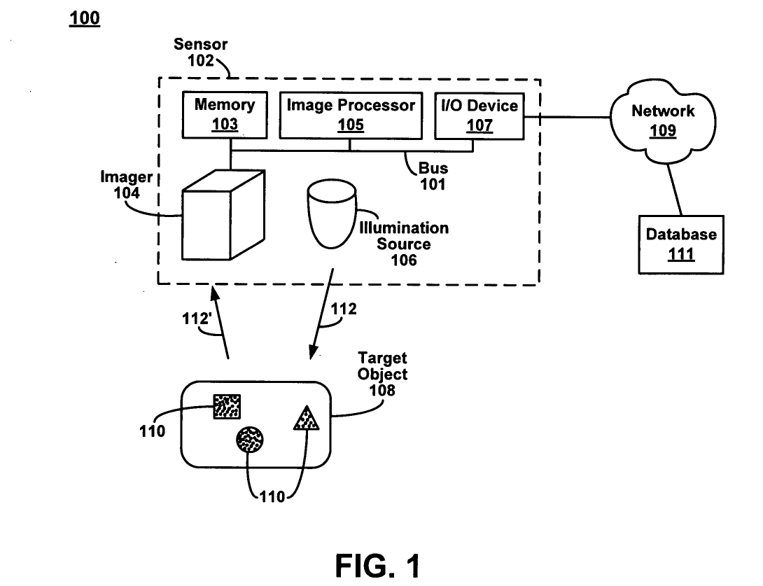

FIG. 1 is a block diagram of an exemplary orientation system 100 in accordance with the invention. The orientation system 100 can be for determining the orientation of a target object 108 using a sensor 102 (e.g., that can include an imager 104, an illumination source 106, among other elements) and retroreflective substrates 110 (e.g., retroreflectors, and the like) on the target 108. As such, depending on the retroreflection or scattering received off of the target object 108 by the imager 104 of the sensor 102, the sensor 102 is able to determine the orientation and/or position of target 108. Note that sensor 102 can measure the position of target object 108 directly, as opposed to integrating acceleration twice in order to measure the position. Specifically, system 100 uses retroreflective substrates 110 where the strength of the scattered or retroreflected signal 112′ varies in a controlled manner with the viewing angle of imager 104, and changes across the retroreflective substrate patches 110 applied to the target 108. It is understood that the orientation and/or position of the target object 108 can be based on a coordinate frame associated with the imager 104, and so the sensor 102 can be calculating the orientation and/or position of the target 108 relative to that. Note that system 100 can be implemented for low-cost consumer applications.

System 100 can include two parts, a sensor system 102 and target object 108. Note that target object 108 can be an input device or controller for, but not limited to, a computing device or gaming apparatus. In accordance with the invention, the target object 108 can be implemented in any shape or form factor that can include one or more retroreflective substrates 110 that can be affixed to and/or embedded into target object 108. In embodiments in accordance with the invention, each retroreflective substrate 110 can be implemented in a wide variety of ways. For example, each retroreflective substrate 110 can be, but is not limited to, a substrate that substantially scatters light or illumination (as opposed to a substrate that substantially allows light or illumination to pass through it), a retroreflector (as shown in FIG. 1), any retroreflective material, any light-scattering material, a substrate that substantially retroreflects light or illumination, any reflective paint, any white-colored paint, any light-colored paint, any material that retroreflects light or illumination at one or more wavelengths of interest, any material that scatters light or illumination at one or more wavelengths of interest, or any combination thereof. It is understood that the orientation of target 108 can be determined or performed by the sensor system 102. The sensor system 102 can be implemented in a wide variety of ways. For example, sensor 102 can be implemented as a small or compact device, e.g., on the order of 1 cubic centimeter (cm³), or it can be attached to or incorporated with a larger device, such as, a mobile telephone, a portable computing device, a portable electronic device, and the like.

It is noted that a retroreflective substrate can include a retroreflector, as mentioned above. As such, it is appreciated that embodiments in accordance with the invention can be readily implemented with any retroreflective substrate. It is understood that a retroreflective substrate can scatter or retroreflect light (or illumination), depending on how the retroreflective substrate is implemented. Therefore, any reference herein to retroreflected light or illumination can also be understood to cover scattered light or illumination depending on the implementation of the retroreflective substrate.

Within FIG. 1, the target object 108 can be constructed or fabricated of a wide variety of material and can also include one or more retroreflectors 110. It is understood that a functional characteristic of retroreflectors 110 is that they are able to reflect light back in predominately the same direction that they initially received the light. Furthermore, retroreflectors 110 can operate over a wide range of incoming angles. Since retroreflectors 110 are passive devices, they do not consume any energy while operating. Moreover, retroreflectors 110 are fairly low cost to purchase thereby contributing to the affordability of orientation system 100. It is desirable for system 100 to be low cost and reliable. It is appreciated that retroreflectors are well known by those of ordinary skill in the art.

During operation, the illumination source 106 can output illumination 112 towards target 108. One or more wavelengths of illumination 112 can be retroreflected by one or more retroreflectors 110 as illumination 112′. The retroreflected illumination 112′ can then be received by imager 104 of sensor 102. As such, the intensity distribution (and/or the relative spacings) of the received image associated with the one or more retroreflectors 110 can be compared by the sensor 102 to a reference retroreflection produced by one or more retroreflectors 110 to determine the orientation of the target object 108. Note that in the case of relative spacings (or separation) between retroreflectors 110, it can involve separation between pairs of retroreflectors 110 that are non-colinear patches or dots. It is understood that sensor 102 can also utilize stored information to determine the orientation of the target object 108. In accordance with the invention, the sensor 102 can access its memory 103, one or more databases 111, and/or one or more networks 109 (e.g., the Internet) for the stored information. Once sensor 102 determines the orientation of target object 108, sensor 102 can output (not shown) the determined orientation of the target object 108 to, for example, a system that can utilize such information. It is noted that sensor 102 can track long, slow movements of target object 108.

It is understood that orientation system 100 of FIG. 1 can be utilized in a wide variety of ways. For example, sensor system 102 could be setup on a laptop display device and could be “looking” down on (or “looking” out at) any kind of target object 108 that had one or more retroreflectors 110 and could be tracking its three-dimensional orientation and/or position. System 100 has at least two advantages for this type of application. For example, the target device 108 does not need a surface underneath it. Moreover, there is no power required by the target object 108 since it can have retroreflectors 110 on it and/or embedded in it. It is noted that for a two-dimensional application, it can be desirable to have a clear view of those retroreflectors 110 over the entire tracking range of target 108 (e.g., a computer mouse) to determine its orientation with respect to a two-dimensional plane or surface (e.g., detect whether target 108 is still on the two-dimensional plane or surface). It is understood that the one or more retroreflectors 110 that can be utilized to determine the orientation of target 108 with respect to a two-dimensional plane or surface are typically perpendicular to the ray normal to the imager 104 of sensor 102.

Within FIG. 1, it is appreciated that there can be illumination source 106 at the imager 104 to provide on-axis illumination 112 to produce the retroreflecting characteristic of illumination 112′. By “on-axis” it can mean that the illumination source 106 can be locate as close as possible to the imager 104 without occluding imager 104 and in a plane parallel to the receiving surface of imager 104. That means that the axis of the beam pattern emanating from the illumination source 106 can be oriented perpendicular to the receiving surface of imager 104, and the light or illumination signal 112′ returned by one or more retroreflectors 110 located in front of the imager 104 will be strong. By using illumination source 106 in this manner, orientation system 100 is able to operate in a room that has very low light or is even dark.

It is appreciated that a user holding the target object 108 can dynamically change the retroreflection signal 112′ received by imager 104 of sensor 102. That is, the retroreflection signal 112′ can vary in a continuous, non-binary, manner due to a cavity depth that varies for one or more retroreflectors 110, or due to varying shape/characteristics of one or more retroreflectors 110. Note that this change in the retroreflection signal 112′ could be used to communicate intent of the user instead of, or in addition to, the orientation information of target 108. It could also be applied to communicate deformations in the target object 108.

Within FIG. 1, it is understood that orientation system 100 includes the target object 108 that can include one or more retroreflectors 110. System 100 also can include illumination source 106 for outputting illumination 112. As previously mentioned, system 100 also can include the imager 104 for receiving the illumination 112′ retroreflected from the one or more retroreflectors 110 of the target object 108 which the sensor 102 can then utilize to determine an orientation of the target object 108. It is understood that the strength of the illumination 112′ retroreflected from the one or more retroreflectors 110 can vary with the viewing angle that the imager 104 has to the one or more retroreflectors 110. It is appreciated that the target object 108 can be, but is not limited to, a gaming controller and/or a controller for a computing device.

The one or more retroreflectors 110 of the target object 108 can be located on a surface and/or at a depth below a surface of the target object 108. Furthermore, the side walls of the cavities can be sloped differently with similar or different depth cavities. Moreover, one or more filters having directional properties can be disposed on one or more retroreflectors 110. For example, the filter can accept and return a different amount of light 112′ depending on the incoming angle of light 112. As such, it is understood that each retroreflector 110 of target 108 can be positioned and/or implemented differently.

For example, each of retroreflectors 110 can be located at a different depth below the surface of target 108. Note that the one or more retroreflectors 110 or target object 108 can be implemented in a wide variety of ways. For example, each retroreflector 110 can be implemented with a different shape, such as, but not limited to, a square, a circle, a triangle, a band or strip, and the like. Note that if two or more retroreflectors 110 are implemented as bands or strips, they can be positioned such that they are parallel, substantially parallel, substantially not parallel, or not parallel to each other. It is understood that the one or more retroreflectors 110 can be utilized for determining the orientation of the target apparatus 108 with respect to a two-dimensional space and/or a three-dimensional space.

Within FIG. 1, note that the illumination source 106 of system 100 can be implemented in a wide variety of ways. For example, the illumination source 106 can be implemented with one or more light emitting diodes (LEDs), one or more vertical cavity surface-emitting lasers (VCSELs) with suitable diffusers if needed to widen the angle of illumination, but is not limited to such. Furthermore, when the illumination source 106 is implemented with multiple sources (e.g., LEDs and/or VCSELs) each source can output illumination at a different wavelength (e.g., visible or non-visible). It is noted that the orientation of a retroreflector 110 can typically be measured with respect to bars perpendicular to a surface of imager 104, but other reference angles are possible.

It is pointed out that sensor 102 can be implemented without illumination source 106. For example, it is possible that the ambient environment may contain sufficient light, thereby making the illumination source 106 unnecessary. In an embodiment in accordance with the invention, sensor 102 could be painted bright white in order to cause light to “come from” sensor 102 toward target object 108.

Within FIG. 1, it is understood that sensor 102 can be implemented in a wide variety of ways in accordance with the invention. For example, sensor 102 can include, but is not limited to, imager 104, illumination source 106, an address/data bus 101, memory 103, an image processor 105, and an input/output (I/O) device 107. The sensor 102 can include address/data bus 101 for communicating information. The imager 104 can be coupled to bus 101 and imager 104 can be for collecting and outputting images to memory 103 and/or image processor 105. The image processor 105 can be coupled to bus 101 and can be for, but is not limited to, processing information and instructions, processing images, analyzing images, making determinations regarding images, and/or making determinations regarding the orientation and/or position of target 108. Note that in an embodiment (but not shown) in accordance with the invention, image processor 105 can be coupled to illumination source 106. In this manner, the image processor 105 can control the operation of illumination source 106 (e.g., by turning illumination source 106 on or off). The memory 103 can be for storing software, firmware, data and/or images and can be coupled to bus 101. The I/O device 107 can be for coupling sensor 102 with external entities and can be coupled to bus 101. In an embodiment in accordance with the invention, I/O device 107 can be a modem for enabling wired and/or wireless communications between sensor 102 and an external network 109 (e.g., the Internet). Also, in an embodiment in accordance with the invention, the I/O device 107 can enable communications between sensor 102 and database 111 via network 109. Note that in an embodiment in accordance with the invention, the I/O device 107 can be communicatively coupled to database 111 without utilizing network 109.

It is understood that imager 104 can be implemented in a wide variety of ways. For example in embodiments in accordance with the invention, imager 104 can include, but is not limited to, a charge-coupled device (CCD) imager, a complementary metal-oxide semiconductor (CMOS) imager, and the like. Note that sensor 102 can be implemented with one or more imagers 104. Additionally, memory 103 can be implemented in a wide variety of ways. For example in embodiments in accordance with the invention, memory 103 can include, but is not limited to, volatile memory, non-volatile memory, or any combination thereof. It is understood that sensor 102 can be implemented to include more or fewer elements than those shown in system 100.

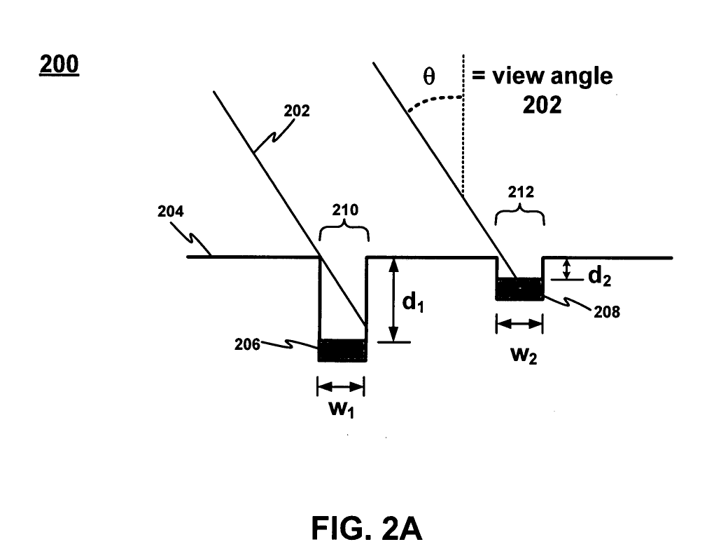

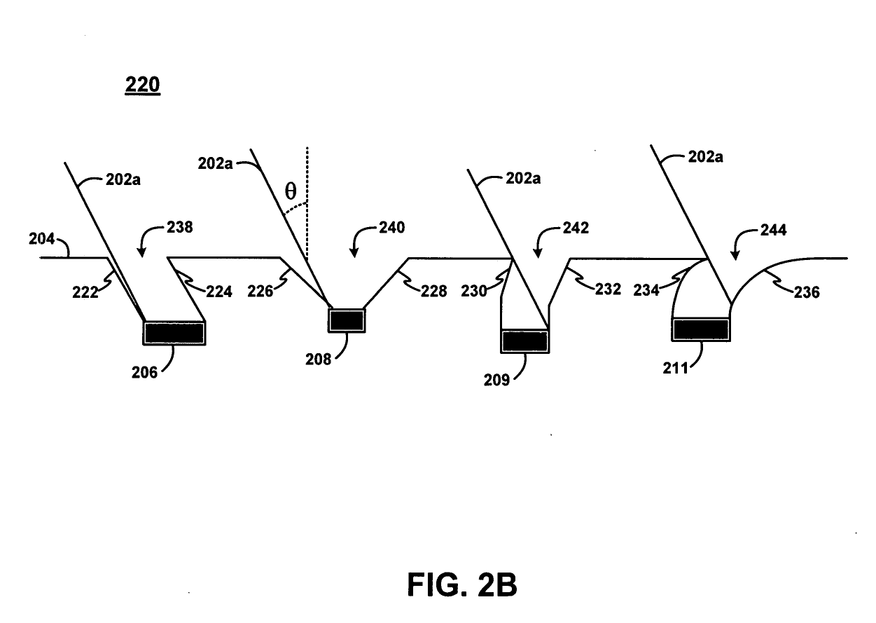

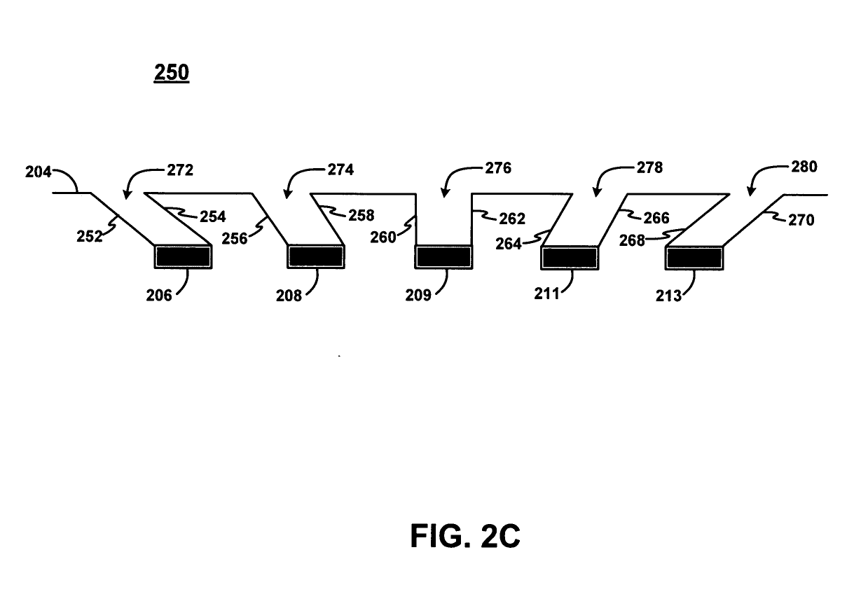

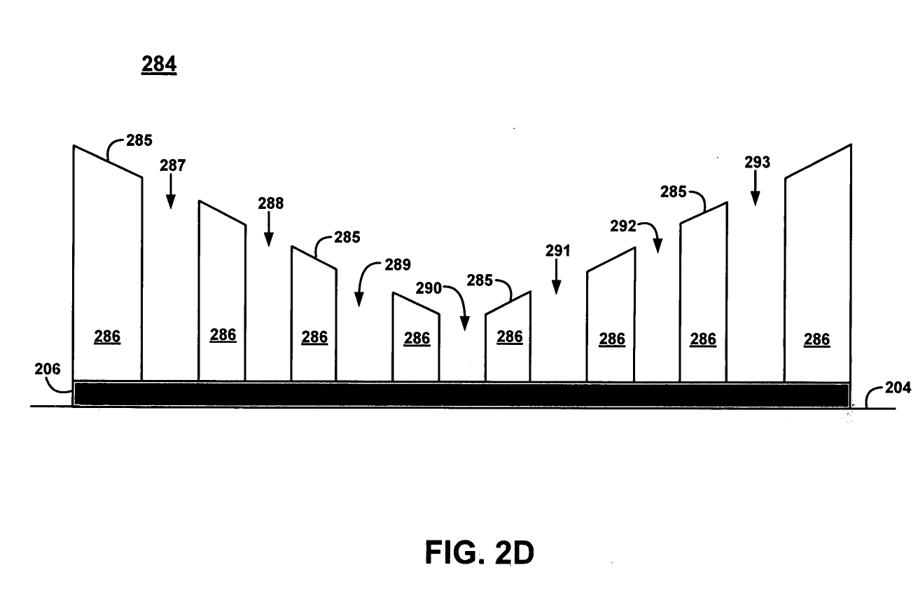

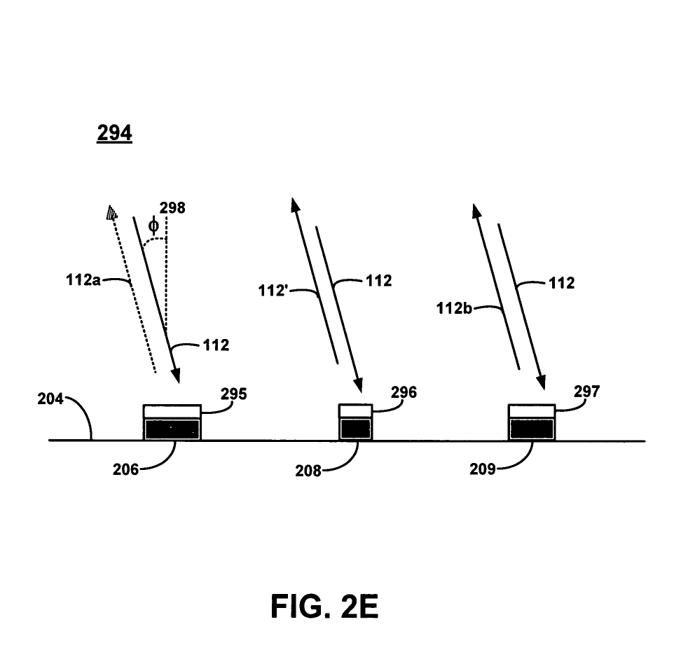

FIG. 2A is a side sectional view 200 of exemplary retroreflectors 206 and 208 that can be implemented within a surface 204 of a target object (e.g., 108) in accordance with the invention. Note that the retroreflectors 206 and 208 are at different depths recessed below a surface 204 of target object 108. It is understood that the one or more retroreflectors 110 of FIG. 1 can be implemented in any manner similar to the retroreflectors 206 and 208 of FIG. 2A, but are not limited to such.

As shown in side sectional view 200, the retroreflector patches 206 and 208 can be contained within cavities 210 and 212, respectively, of variable depth (e.g., d₁ and d₂). As such, it is understood that depending on the viewing angle (θ) 202 of imager 104 to retroreflectors 206 and 208 determines how much (if any) illumination is retroreflected to it by each one. For example, when viewed from the direction defined by view angle θ 202, the retroreflector 206 is completely occluded, while the retroreflector 208 is approximately 50% occluded. However, when viewed from directly above, view angle θ 202=0, both of retroreflector patches 206 and 208 are fully visible. Therefore, depending on which (if any) retroreflector patches 206 and 208 are retroreflecting illumination 112′ to imager 104, the sensor 102 can utilize this information to determined the orientation of the target apparatus 108. It is understood that this information can be based on predefined resultant images or illumination characteristics (e.g., as mentioned above) of what would be received by imager 104 from the target object 108 in its desirable (or possible) orientations for its particular application.

Within FIG. 2A, it is noted that the depth of cavities 210 and 212 vary (or are different), but the widths (e.g., w₁ and w₂) of retroreflectors 206 and 208 can also vary (or be different). Furthermore, it is pointed out that the aspect ratio (β) can be represented as: β=d/w. It is appreciated that that retroreflector patches 206 and 208 can be distinct, as shown in side sectional view 200, or can each be formed into a continuous retroreflector band or strip.

It is pointed out that instead of implementing retroreflector patches 206 and 208 within cavities 210 and 212, respectively, the retroreflectors 206 and 208 themselves could be specifically constructed to generate the same effect as described herein with reference to FIG. 2A. In this case, the retroreflectors 206 and 208 could all lie on the same surface 204 of target 108, and cavities (e.g., 210 and 212) would not be used.

FIG. 2B is a side sectional view 220 of exemplary retroreflectors 206, 208, 209 and 211 that are implemented within surface 204 of a target object (e.g., 108) in accordance with the invention. It is note that retroreflectors 206, 208, 209 and 211 are located at different depths recessed within cavities 238, 240, 242 and 244, respectively, below surface 204 of target object 108. Furthermore, the side walls that form cavities 238, 240, 242 and 244 can be formed in a wide variety of ways.

For example, exemplary side walls 222 and 224 of cavity 238 illustrate that side walls can be implemented such that their slopes are substantially parallel. Additionally, exemplary side walls 226 and 228 of cavity 240 illustrate that each side wall can be sloped differently than the other. Moreover, exemplary side walls 230 and 232 of cavity 242 illustrate that each side wall can be implemented to include one or more angles that are different than the other. Furthermore, exemplary side walls 234 and 236 of cavity 244 illustrate that each side wall can be implemented with a curved (or non-planar) surface. It is understood that the one or more retroreflectors 110 of FIG. 1 can be implemented in any manner similar to the retroreflectors 206, 208, 209 and 211 of FIG. 2B, but are not limited to such.

Within FIG. 2B, it is understood that depending on the viewing angle (θ) 202a of imager 104 to retroreflectors 206, 208, 209 and 211 determines how much (if any) illumination is retroreflected to it by each one. For example, when viewed from the direction defined by viewing angle θ 202a, the retroreflectors 209 and 211 are completely occluded, while the retroreflectors 206 and 208 are substantially visible. However, when viewed from a different view angle, other retroreflector patches may be occluded, partially occluded, partially visible and/or fully visible. Therefore, depending on which (if any) of the retroreflector patches 206, 208, 209 and 211 are retroreflecting illumination 112′ to imager 104, the sensor 102 can utilize this information to determined the orientation of the target apparatus 108. Note that this information can be based on predefined resultant images or illumination characteristics (e.g., as mentioned above) of what would be received by imager 104 from the target object 108 in its desirable (or possible) orientations for its particular application.

FIG. 2C is a side sectional view 250 of exemplary retroreflectors 206, 208, 209, 211 and 213 that are implemented within surface 204 of a target object (e.g., 108) in accordance with the invention. It is note that retroreflectors 206, 208, 209, 211 and 213 are located at substantially the same depth recessed within cavities 272, 274, 276, 278 and 280, respectively, below surface 204 of target object 108. Furthermore, the side walls that form cavities 272, 274, 276, 278 and 280 each have a different orientation.

For example, exemplary side walls 252 and 254 of cavity 272 are substantially parallel and are strongly angled to the left in relation to surface 204 while exemplary side walls 256 and 258 of cavity 274 are substantially parallel and are not so strongly angled to the left in relation to surface 204. Additionally, exemplary side walls 260 and 262 of cavity 276 are substantially parallel and are substantially perpendicular in relation to surface 204. Furthermore, exemplary side walls 268 and 270 of cavity 280 are substantially parallel and are strongly angled to the right in relation to surface 204 while exemplary side walls 264 and 266 of cavity 278 are substantially parallel and are not so strongly angled to the right in relation to surface 204. Note that the one or more retroreflectors 110 of FIG. 1 can be implemented in any manner similar to the retroreflectors 206, 208, 209, 211 and 213 of FIG. 2C, but are not limited to such.

Within FIG. 2C, it is appreciated that depending on the viewing angle (not shown) of imager 104 to retroreflectors 206, 208, 209, 211 and 213 determines how much (if any) illumination is retroreflected to it by each one. Therefore, depending on which (if any) of the retroreflector patches 206, 208, 209, 211 and 213 is retroreflecting illumination (e.g., 112′) to imager 104, the sensor 102 can utilize this information to determine the orientation and/or position of the target apparatus 108. Note that this information can be based on predefined resultant images or illumination characteristics (e.g., as mentioned above) of what would be received by imager 104 from the target object 108 in its desirable (or possible) orientations and/or positions for its particular application.

FIG. 2D is a side sectional view 284 of an exemplary retroreflector 206 that is implemented with a mask (or cover plate) 286 that are implemented as part of surface 204 of a target object (e.g., 108) in accordance with the invention. Specifically, mask 286 forms cavities 287, 288, 289, 290, 291, 292 and 293 above retroreflector 206. As such, when viewed from above, mask 286 can cause retroreflector 206 to appear as multiple retroreflectors located at different depths in relation to an upper sloped surface 285 of mask 286. Note that the one or more retroreflectors 110 of FIG. 1 can be implemented in any manner similar to retroreflector 206 and mask 286 of FIG. 2D, but are not limited to such.

Note that depending on the viewing angle (not shown) of imager 104 to the mask 286 and retroreflector 206 determines how much (if any) illumination is retroreflected to it by each portion of retroreflector 206. Therefore, depending on which (if any) portion of the retroreflector 206 is retroreflecting illumination (e.g., 112′) to imager 104, the sensor 102 can utilize this information to determine the orientation and/or position of the target apparatus 108. Note that this information can be based on predefined resultant images or illumination characteristics (e.g., as mentioned above) of what would be received by imager 104 from the target object 108 in its desirable (or possible) orientations and/or positions for its particular application.

It is understood that one of the advantages of implementing retroreflector 206 with mask (or cover plate) 286 as shown in FIG. 2D is that its fabrication cost may be lower when compared to the fabrication cost of other embodiments (e.g., FIGS. 2A, 2B, or 2C) in accordance with the invention.

FIG. 2E is a side sectional view 294 of exemplary retroreflectors 206, 208 and 209 that are implemented on surface 204 of a target object (e.g., 108) in accordance with the invention. Note that retroreflectors 206, 208 and 209 can each have a filter disposed above it that includes directional properties. That is, each filter can receive illumination 112 and return a different amount of illumination depending on the incoming angle of illumination 112.

For example, when illumination 112 is received by exemplary filter 295 and retroreflector 206 at an incoming angle of phi (φ) 298, filter 295 can cause retroreflector 206 to produce a limited or reduced amount of retroreflected illumination 112a (as indicated by dashed arrow 112a). Furthermore, when illumination 112 is received by exemplary filter 297 and retroreflector 209 at an incoming angle of φ 298, filter 297 can cause retroreflector 209 to produce an even weaker amount of retroreflected illumination 112b (as indicated by gray arrow 112b). However, when illumination 112 is received by exemplary filter 296 and retroreflector 208 at an incoming angle of φ 298, filter 296 can cause retroreflector 208 to produce a retroreflected illumination 112′ that is substantially similar in strength to incoming illumination 112′. It is understood that the outgoing angle of illumination 112′, 112a and 112b are approximately equal to the incoming angle of φ 298.

Within FIG. 2E, it is understood that depending on which (if any) of the retroreflector patches 206, 208 and 209 are retroreflecting illumination to imager 104 and the strength or amount of that illumination, the sensor 102 can utilize this information to determined the orientation of the target apparatus 108. It is appreciated that this information can be based on predefined resultant images or illumination characteristics (e.g., as mentioned above) of what would be received by imager 104 from the target object 108 in its desirable (or possible) orientations for its particular application.

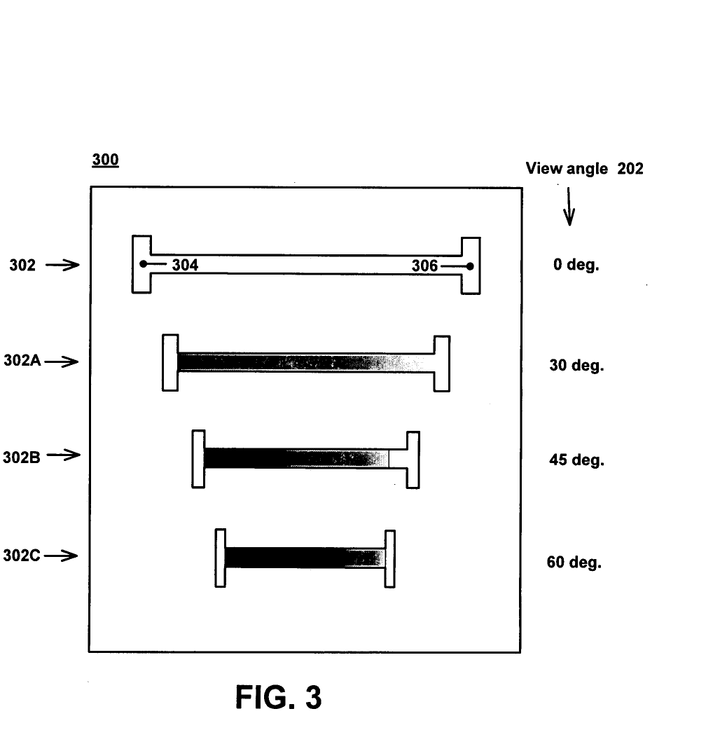

FIG. 3 is a diagram 300 showing an exemplary continuous retroreflector band 302 when viewed at different angles in accordance with the invention. As such, bands 302A, 302B, and 302C are different views of retroreflector band 302. Furthermore, it is appreciated that diagram 300 is showing different retroreflected light or illumination patterns (e.g., 302, 302A, 302B, and 302C) that can be received by imager 104. Note that the view angle 202 can be equivalent to the orientation angle of the target object 108 with respect to the imager 104 (or a viewer).

If the distance to the target 108 is known, then the length of the bands 302, 302A, 302B, and 302C are sufficient to indicate the orientation of target apparatus 108. Unfortunately, the distance to the target 108 is not usually known. In that case, the intensity distribution, when referenced to the end points on the band (e.g., 302, 302A, 302B, and 302C) can be sufficient to indicate orientation (and/or position).

Within FIG. 3, it is pointed out that the white bands (e.g., 304 and 306) on the end of retroreflector band 302 are markers that can indicate the ends of band 302. Note that markers 304 and 306 can be located at the surface (e.g., 204) of the target object 108. It is understood that depending on the viewing angle 202 and distance from retroreflector band 302, the length of retroreflector band 302 is going to appear shorter or longer to the imager 104 of sensor 102. For example, when the viewing angle 202 is substantially equal to zero degrees, the projected length of retroreflector band 302 appears to be its longest length. However, when the viewing angle 202 is substantially equal to plus or minus 30 degrees, the projected length of the retroreflector band 302A appears to be a little shorter. Moreover, when the viewing angle 202 is substantially equal to plus or minus 45 degrees, the projected length of the retroreflector band 302B appears to be shorter still. Furthermore, when the viewing angle 202 is substantially equal to plus or minus 60 degrees, the projected length of the retroreflector band 302C appears to be even shorter in length. Therefore, sensor 102 can include image processing that can differentiate between the received images associated with bands 302, 302A, 302B, and 302C. For example, the sensor 102 might use some relative value between the end points 304 and 306 and how far it is from one of the end markers 304 and 306.

It is noted that the determination of the viewing angle 202 by the sensor 102 can be based on the amount of retroreflected light received by imager 104, relative to other retroreflected light, such as, the retroreflected light received from the end markers 304 and 306 that will not be occluded when located on the surface (e.g., 204) of target apparatus 108.

Within FIG. 3, one of the reasons for utilizing end markers 304 and 306 with retroreflector band 302 is to indicate the location of each of its ends. For example, when the viewing angle 202 is substantially equal to 45 and 60 degrees, it would be difficult to know where the end of bands 302B and 302C are on their left side without utilizing end marker 304. However, there are other ways the length of bands 302-302C can be determined. For example in embodiments in accordance with the invention, a black line or black region could be implemented in the center of retroreflector band 302 to be utilized as a reference point.

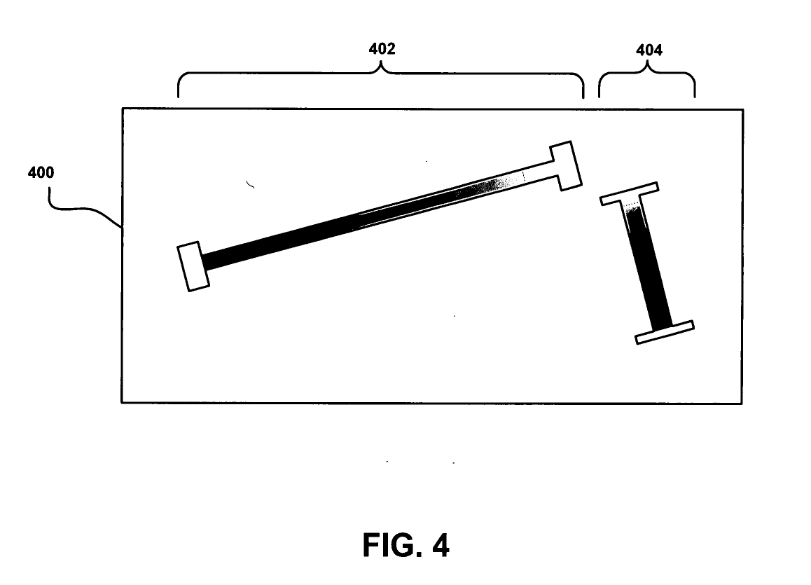

FIG. 4 is a diagram 400 showing exemplary continuous retroreflector bands 402 and 404 that can be utilized for determining three-dimensional orientation (and/or position) of a target apparatus (e.g., 108) in accordance with the invention. Specifically, since retroreflector bands 402 and 404 are projecting light or illumination that is not symmetric, a third orientation angle can also be determined that is associated with the target object 108.

It is noted that retroreflector bands 402 and 404 can be positioned such that they are substantially orthogonal (or not parallel), as shown. However, retroreflector bands 402 and 404 can also be positioned such that they are substantially parallel. It is understood that a greater number of retroreflector bands can be used than the two retroreflector bands 402 and 404. Furthermore, retroreflector bands 402 and 404 can be implemented in a wide variety of ways. For example, retroreflectors 402 and 404 do not have to be implemented as bands, but instead, can be implemented in any manner similar to that described herein. It is pointed out that the illustrations of FIG. 4 are with the target object 108 having a substantially flat surface (e.g., 204). However, the target object 108 can have any non-flat or non-planar surface 204. Note that the sensor 102 will be implemented to the shape and form of the target object 108. As such, the sensor 102 will have the information that it will utilize to determine the orientation (and/or position) of the target object 108. The sensor 102 will be interpreting the retroreflected light received by imager 104 with respect to some sort of reference retroreflection. In an embodiment in accordance with the invention, the sensor 102 can quantify gray scale levels. For example, when implemented with an 8 bit processor (e.g., 105), that is equivalent to 256 levels.

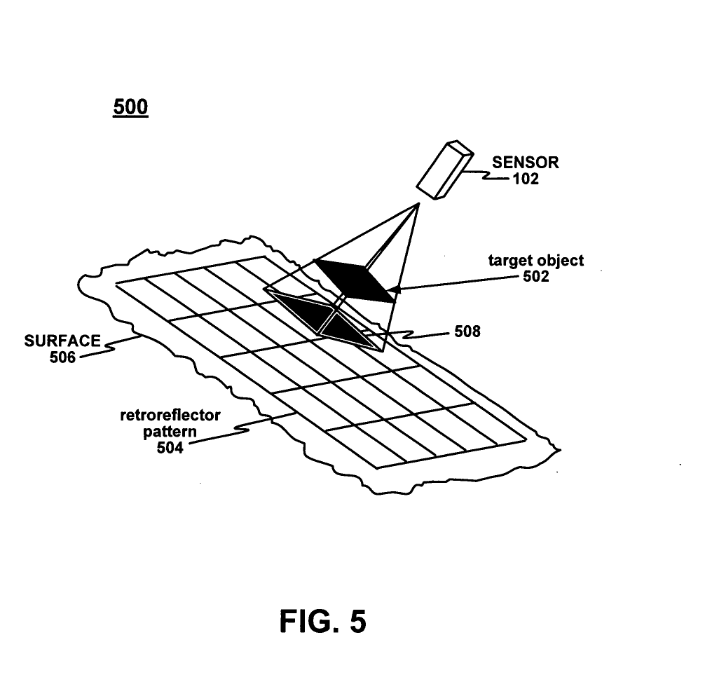

FIG. 5 is a block diagram of an exemplary orientation system 500 in accordance with the invention. It is noted that orientation system 500 uses a target object (or apparatus) 502 to partially occlude a retroreflective substrate pattern 504 (e.g., a retroreflector pattern as shown in FIG. 5). Specifically, depending on the orientation (and/or position) of the target object 502 with respect to the imager 104 (not shown) of sensor 102, where the shadowed occlusion 508 occurs on the retroreflective substrate pattern 504 can be utilized by the sensor 102 to determine the orientation (and/or position) of target object 502.

In embodiments in accordance with the invention, the retroreflective substrate pattern 504 can be implemented in a wide variety of ways. For example, the retroreflective substrate pattern 504 can be, but is not limited to, a substrate pattern that substantially scatters light or illumination (as opposed to a substrate pattern that substantially allows light or illumination to pass through it), a retroreflector pattern (as shown in FIG. 5), any retroreflective material pattern, any light-scattering material pattern, a substrate pattern that substantially retroreflects light or illumination, any reflective paint pattern, any white-colored paint pattern, any light-colored paint pattern, any pattern of material that retroreflects light at one of more wavelengths of interest, any pattern of material that scatters light at one or more wavelengths of interest, or any combination thereof.

It is understood that the target object 502 is located above the retroreflector pattern 504, which is located on a surface 506. Note that the gray shaded area 508 is the region of the retroreflector pattern 504 that is occluded by the target object 502. From the point of view of the imager 104 of sensor 102, the shaded area 508 can be hidden behind the target object 502.

Within FIG. 5, it is pointed out that the target object 502 can be implemented in a wide variety of ways. For example, the target object 502 can be implemented in any shape or form. Furthermore, the target object 502 can be implemented with one or more parts. For example, the “black patch” representing target 502 can be implemented as multiple patches. That is, more that one target 502 can be utilized within system 500. Moreover, the target object 502 can form one or more holes or apertures thereby enabling illumination to pass through it. Therefore, the shape and form of the target 502 can be utilized by the sensor 102 to determine the orientation (and/or position) of the target 502. For example, if the target 502 includes a hole through it, the sensor 102 can determine the specific orientation (and/or position) of the target 502 when the imager 104 receives through the hole the known particular portion of the retroreflector pattern 504.

It is also understood that the retroreflector pattern 504 can be implemented in a wide variety of ways. For example, the retroreflector pattern 504 can be implemented as a grid array, as shown. However, the retroreflector pattern 504 can be implemented such that it is the inverse of the grid array shown. Moreover, the retroreflector pattern 504 can be implemented as any type of pattern of dots, lines, shapes or any combination thereof. Note that the retroreflector pattern 504 can be implemented as a repeating pattern or a unique non-repeating pattern. The retroreflector pattern 504 can lie on or be part of a substantially planar surface, such as surface 506. However, the retroreflector pattern 504 can also lie on a substantially non-planar surface.

Within FIG. 5, note that the imager 104 of sensor 102 is seeing or viewing the retroreflecting portions of the retroreflector pattern 504. As such, whatever part of the retroreflector pattern 504 is being occluded by shadow 508, that part enables the sensor 102 to determine the orientation (and/or position) of the target apparatus 502. As such, the sensor 102 can be implemented beforehand to know the entire retroreflector pattern 504 along with the varying shapes of shadows 508 that can be cast or blocked out by target object 502. For example, the patch or card implementation of target 502 could produce a big shadow 508 and no shadow, depending on its orientation or position. Moreover, the sensor 102 can utilize this information to determine which way the target 502 is moving based on where it is in the next frame. It is understood that a good amount of tracking issues come down to uniquely identifying or having confidence that the same object is being tracked from frame to frame.

The orientation system 500 can include one or more target objects 502 along with the surface 506 that can include the retroreflector pattern 504. Note that sensor 102 of system 500 can be implemented in any manner similar to that described herein, but is not limited to such. System 500 can also include the illumination source 106 (of sensor 102) for outputting illumination (e.g., 112). The orientation system 500 can also include the imager 104 (of sensor 102) for receiving the illumination (e.g., 112′) retroreflected from the retroreflector pattern 504 which can be utilized by sensor 102 to determine an orientation (and/or position) of the target object 502. It is understood that the target object 502 can be implemented in a wide variety of ways. For example, target 502 can be implemented in any manner similar to that described herein, but is not limited to such. The target object 502 can be located between the surface 506 and the illumination source 106, but is not limited to such. Furthermore, the target object 502 can be located between, but is not limited to, the retroreflector pattern 504 and the sensor 102 (which can include imager 104 and illumination source 106).

As previously mentioned, the sensor 102 can be implemented to determine, based on the point of view of imager 104, the orientation (and/or position) of the target object 502 based on what portion 508 of the retroreflector pattern 504 is occluded by the target object 108. It is noted that the surface 506 that includes the retroreflector pattern 504 can be substantially planar or substantially non-planar.

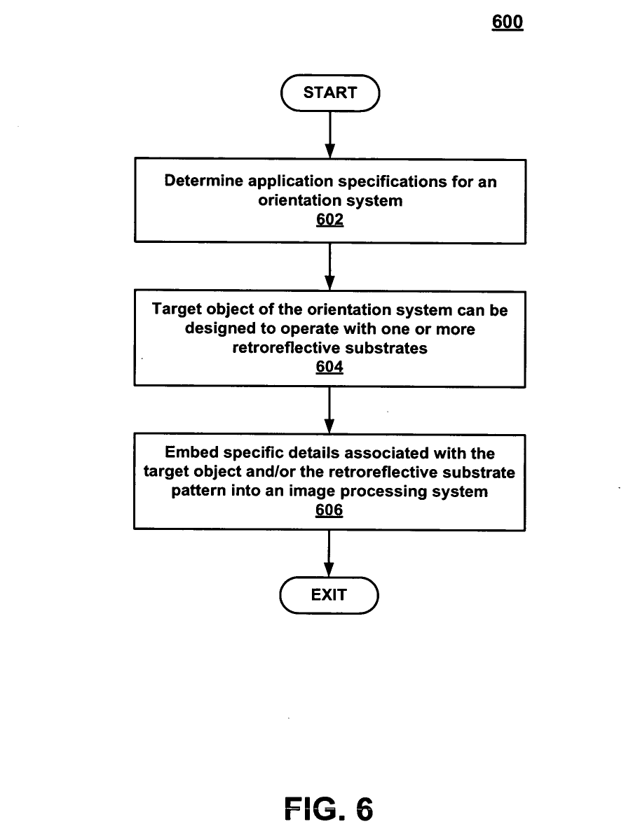

FIG. 6 is a flow diagram of a method 600 for designing an orientation system in accordance with the invention. Although specific operations are disclosed in method 600, such operations are exemplary. Method 600 may not include all of the operations illustrated by FIG. 6. Also, method 600 may include various other operations and/or variations of the operations shown by FIG. 6. Likewise, the sequence of the operations of method 600 can be modified. It is noted that the operations of method 600 can be performed by software, by firmware, by electronic hardware, by fabrication tools, or by any combination thereof.

Specifically, a determination can be made as to what the application specifications are going to be for an orientation system. Furthermore, a target object of the orientation system can be designed to operate in conjunction with one or more retroreflective substrates. The specific details associated with the target object can be input or embedded into an image processing system. In this manner, an orientation system can be designed in accordance with the invention.

At operation 602 of FIG. 6, a determination can be made as to what the application specifications are going to be for an orientation system (e.g., 100 or 500). It is noted that operation 602 can be implemented in a wide variety of ways. For example, the application specifications of operation 602 can include, but are not limited to, orientation range of system, resolution of system, distance range, resolution of imager (e.g., 104), field-of-view of imager (e.g., 104), design constraints of a target object (e.g., 108 or 502), and the like. It is understood that operation 602 can be implemented in any manner similar to that described herein, but is not limited to such.

At operation 604, the target object (e.g., 108 or 502) of the orientation system can be designed to operate in conjunction with one or more retroreflective substrates (e.g., 110, 206, 208, 209, 211, 213, 302, 402, 404, and/or 504). It is appreciated that operation 604 can be implemented in a wide variety of ways. For example, the design of the target object at operation 604 can include, but is not limited to, the shape of the target object, where one or more retroreflective substrates are going to be embedded within a surface of the target object, the depth and/or width of the cavities for the one or more retroreflective substrates, the shape of the one or more retroreflective substrates associated with the target object, the retroreflective substrate pattern (e.g., 504) that may be associated with the target object, the location of the one or more retroreflective substrates on the target object, and the like. It is noted that operation 604 can be implemented in any manner similar to that described herein, but is not limited to such.

At operation 606 of FIG. 6, the specific details associated with the target object (e.g., 108 or 502) and/or retroreflective substrate pattern (e.g., 504) can be input or embedded into an image processing system (e.g., 102). It is noted that operation 606 can be implemented in a wide variety of ways. For example in embodiments in accordance with the invention, the specific details associated with the target object and/or retroreflective substrate pattern can be input or embedded into memory (e.g., 103) of the image processing system via an I/O device (e.g., 107), but is not limited to such. Operation 606 can be implemented in any manner similar to that described herein, but is not limited to such. At the completion of operation 606, process 600 can be exited.

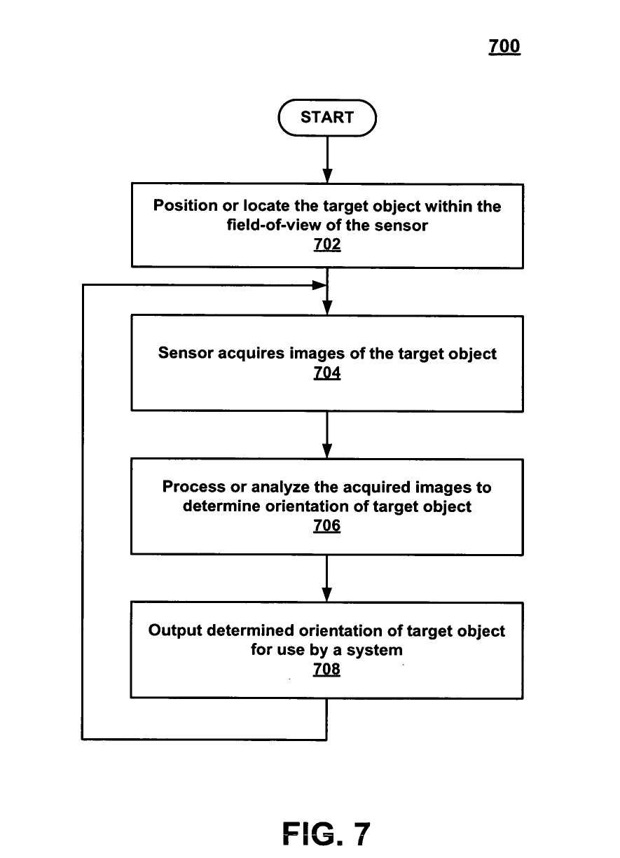

FIG. 7 is a flow diagram of a method 700 for operating an orientation system in accordance with the invention. Although specific operations are disclosed in method 700, such operations are exemplary. Method 700 may not include all of the operations illustrated by FIG. 7. Also, method 700 may include various other operations and/or variations of the operations shown by FIG. 7. Likewise, the sequence of the operations of method 700 can be modified. It is noted that the operations of method 700 can be performed by software, by firmware, by electronic hardware, by fabrication tools, or by any combination thereof.

Specifically, a target object of an orientation system can be positioned or located within the field-of-view (FOV) of a sensor apparatus. The sensor apparatus can then acquire images of the target object. Furthermore, the acquired images can be processed or analyzed in order to determine the orientation (and/or position) of the target object. Additionally, the determined orientation (and/or position) of the target object can be output for use by a system. In this manner, an orientation system can operate in accordance with the invention.

At operation 702 of FIG. 7, a target object (e.g., 108 or 502) of an orientation system (e.g., 100 or 500) can be positioned or located within the field-of-view of a sensor apparatus (e.g., 102). It is noted that operation 702 can be implemented in a wide variety of ways. For example in embodiments in accordance with the invention, the sensor apparatus of operation 702 can be implemented in any manner similar to that described herein, but is not limited to such. In embodiments in accordance with the invention, the target object of operation 702 can be implemented to include one or more retroreflective substrates (e.g., 110) in any manner similar to that described herein, but is not limited to such. It is understood that operation 702 can be implemented in any manner similar to that described herein, but is not limited to such.

At operation 704, the sensor apparatus can then acquire or capture images of the target object within its field-of-view. Note that operation 704 can be implemented in a wide variety of ways. For example in an embodiment in accordance with the invention, at least one imager (e.g., 104) of the sensor apparatus can acquire or capture images of the target object within its field-of-view that can included retroreflected or scattered illumination from the one or more retroreflective substrates of the target object. It is appreciated that operation 704 can be implemented in any manner similar to that described herein, but is not limited to such.

At operation 706 of FIG. 7, the acquired or captured images can be processed or analyzed in order to determine the orientation and/or position of the target object. It is appreciated that operation 706 can be implemented in a wide variety of ways. For example in an embodiment in accordance with the invention, at least one image processor (e.g., 105) of the sensor apparatus can process or analyze the acquired or captured images to determine the orientation and/or position of the target object. In an embodiment in accordance with the invention, the acquired or captured images can be processed or analyzed remotely from the sensor apparatus to determine the orientation and/or position of the target object. Note that operation 706 can be implemented in any manner similar to that described herein, but is not limited to such.

At operation 708, the determined orientation (and/or position) of the target object and maybe other information associated with the target object can be output or transmitted for use by a system. It is understood that operation 708 can be implemented in a wide variety of ways. For example, the other information associated with the target object can include, but is not limited to, how fast the target object is moving, the distance to the target object from the sensor apparatus, and the like. Note that operation 708 can be implemented in any manner similar to that described herein, but is not limited to such. At the completion of operation 708, process 700 can proceed to repeat operations 704, 706 and 708.

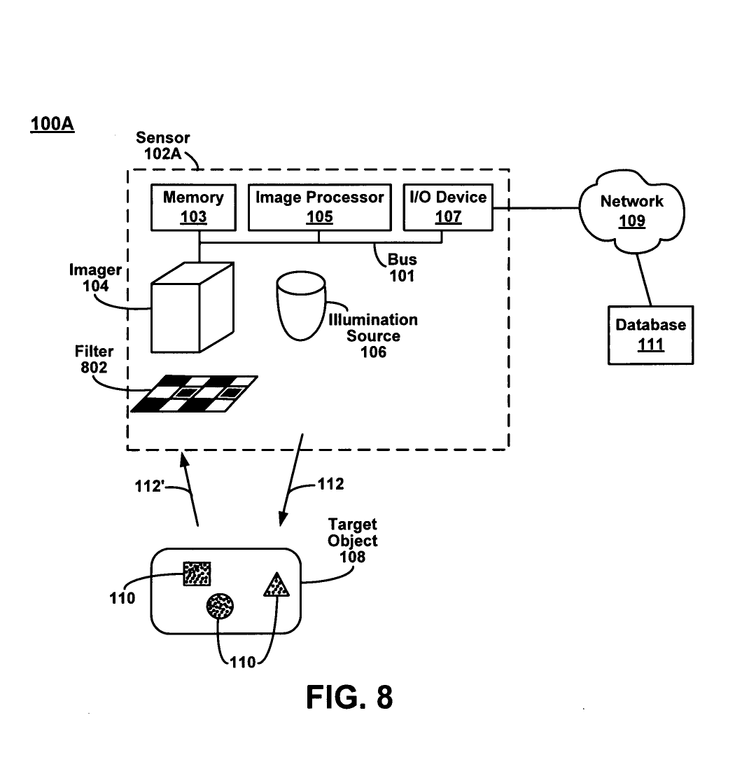

FIG. 8 is a block diagram of an exemplary orientation system 100A in accordance with the invention. It is noted that system 100A of FIG. 8 is similar to system 100 of FIG. 1. However, system 100A of FIG. 8 includes a filter 802. It is understood that filter 802 can be implemented with any embodiment in accordance with the invention described herein. In an embodiment in accordance with the invention, the filter 802 can be utilized to enable sensor 102A to more easily differentiate retroreflective substrates 110 from other artifacts within the field of view of imager 104. For example in an embodiment in accordance with the invention, the filter 802 can be utilized to filter out room lights and/or ambient lighting that could have otherwise been received by the imager 104. Note that the filter 802 can be patterned on the surface of imager 104 in a checkerboard pattern, but is not limited to such. It is appreciated that the filter 802 can be implemented in a wide variety of ways.

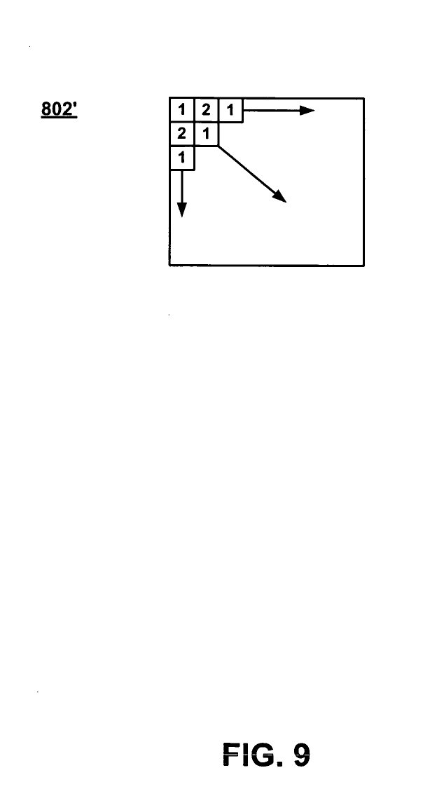

FIG. 9 is a block diagram of an exemplary filter 802′ in accordance with the invention. The filter 802′ can include one or more microfilters and/or polarizers, but is not limited to such. Within the filter 802′, a checkerboard pattern can be formed using two types of filters according to the wavelengths being used by multiple light sources 106 (not shown). That is, for example, filter 802′ can include regions (identified as 1) that include a filter material for filtering a first wavelength, and other regions (identified as 2) that include a filter material for filtering a second wavelength. The filter 802′ can be incorporated into sensor 102A (FIG. 8). It is appreciated that the different filter materials of filter 802′ can be arrayed in a pattern other than a checkerboard pattern. For example, the patterned filter layer 802′ can be formed into an interlaced striped or a non-symmetrical configuration, but is not limited to such. Additionally, filter 802′ can be implemented to include more or fewer than two filter materials, wherein each filter material is for filtering a different wavelength. The filter materials of filter 802′ can be deposited (e.g., layered) as a separate layer of sensor 102A (e.g., on top of an underlying layer) using conventional deposition and photolithography processes while still in wafer form, reducing the cost to manufacture. Additionally or alternatively, the filter materials of filter 802′ may be mounted as separate elements between the sensor 102A and incident light, allowing bulk or uniform filtering of light before the light reaches the surface of imager 104.

In another embodiment in accordance with the invention, one, two or more filter materials of filter 802′ can be patterned onto the imager 104 in wafer form while a complementary large area filter can blanket the entire imager 104. Various types of filters can be used for the small and large filters, including but not limited to, polymers doped with pigments or dyes, interference filters, reflective filters, and absorbing filters made of semiconductors, other inorganic materials, or organic materials. In yet another embodiment in accordance with the invention, the wavelength and/or gain sensitivity may be varied within the silicon pixels of imager 104 in a checkerboard pattern or non-checkerboard pattern.

It is noted that in embodiments in accordance with the invention, sensor 102A can analysis the image results received through filter 802′ by imager 104 in a wide variety of ways. For example in an embodiment in accordance with the invention, filter portions 1 of filter 802′ can be implemented to allow both scattered or retroreflected illumination (e.g., 112′) and ambient illumination pass through each of them to imager 104 while the filter portions 2 of filter 802′ can be implemented to just allow the ambient illumination pass though each of them to imager 104. As such, sensor 102 can subtract a quarter of the ambient illumination received through each filter portion 2 by imager 104 from an adjacent ambient illumination received through each filter portion 1 by imager 104. In this manner, sensor 102 can more easily differentiate or distinguish the scattered or retroreflected illumination (e.g., 112′) from the ambient illumination that passes through filter portions 1.

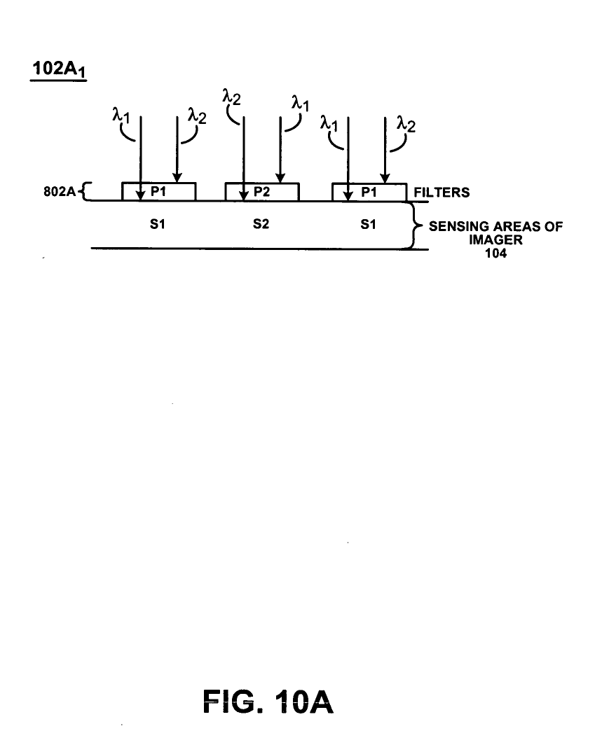

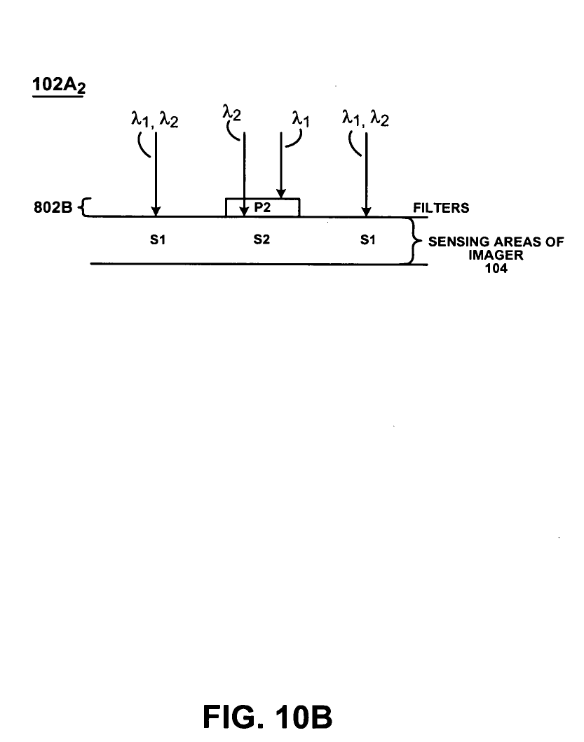

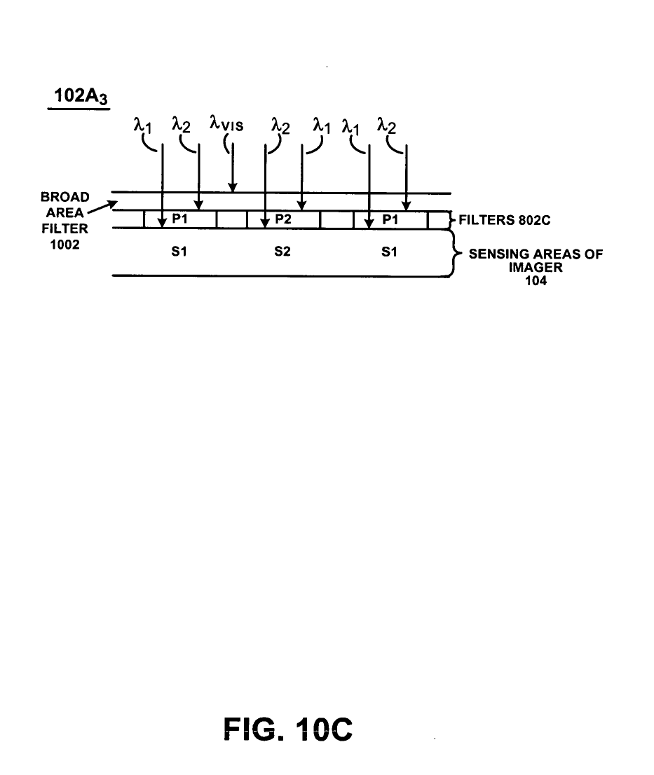

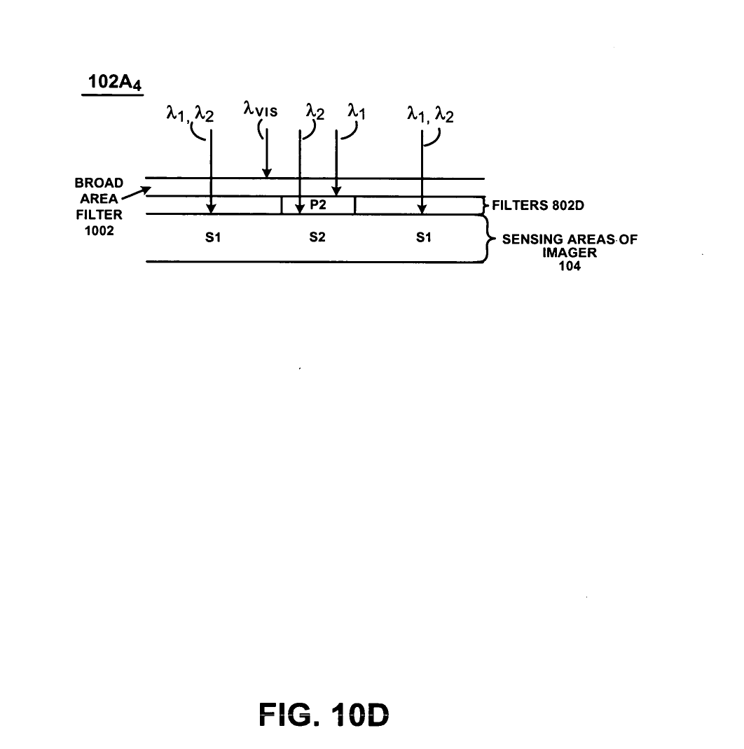

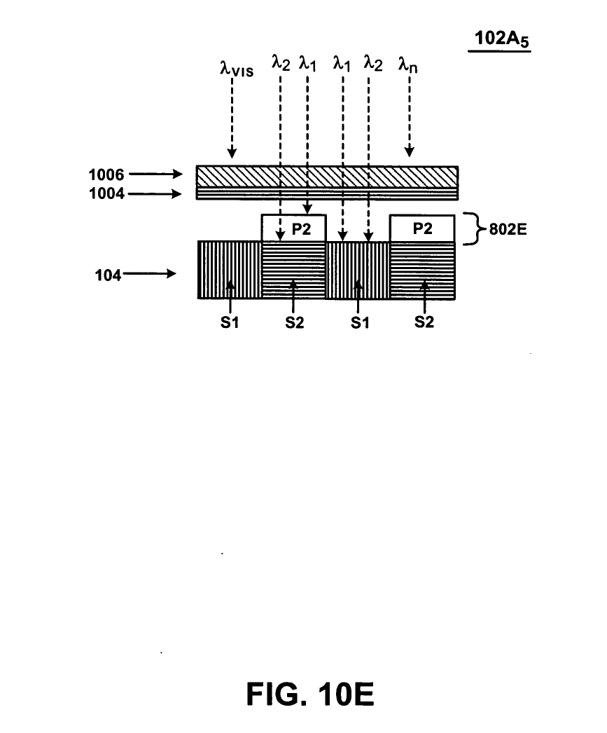

FIG. 10A is a cross-sectional diagram illustrating an exemplary sensor 102A, in accordance with the invention. It is understood that only a portion of the sensor 102A₁, is illustrated in FIG. 10A. Within sensor 102A₁, sensing areas S1 of imager 104 are for detecting illumination at a first wavelength (λ₁), and sensing areas S2 of imager 104 are for detecting illumination at a second wavelength (λ₂). It is understood that each of the sensing areas S1 and S2 can be a pixel of imager 104, but is not limited to such. The filter portions P1 and P2 of filter 802A can be inorganic films, polymer films, vapor-deposited films, etc. It is appreciated that the filters P1 and P2 each have different transmission properties for filtering out illumination at the second and first wavelengths (λ₂ and λ₁, respectively). For example, polymer films may use different pigments or dyes, and inorganic films may use thin metal layers, semiconductor materials, or dielectric materials.

FIG. 10B is a cross-sectional diagram illustrating an exemplary sensor 102A₂ in accordance with the invention. It is understood that only a portion of the sensor 102A₂ is illustrated in FIG. 10B. The sensor 102A₂ can include filter 802B that can include a filter portion (e.g., P2) that can be disposed over one set of sensing areas (e.g., S2) of imager 104. As such, illumination of a first wavelength (λ₁) and a second wavelength (λ₂) are allowed to be sensed at sensing areas S1 of imager 104, while filter portions P2 just allow illumination of the second wavelength (λ₂) to be sensed at sensing areas S2.

FIG. 10C is a cross-sectional diagram illustrating an exemplary sensor 102A₃ in accordance with the invention. It is understood that only a portion of the sensor 102A₃ is illustrated in FIG. 10C. The sensor 102A₃ can include a broad area filter 1002 that can be disposed over the filter 802C that can include filter portions P1 and P2. Note that the broad area filter 1002 can be for blocking visible light (λ_{VIS}) from the sensing areas S1 and S2 of imager 104. It is understood that the P1 and P2 filter portions of filter 802C can operate in a manner similar to filter 802A, as described herein.

FIG. 10D is a cross-sectional diagram illustrating an exemplary sensor 102A₄ in accordance with the invention. It is understood that only a portion of the sensor 102A₄ is illustrated in FIG. 10D. The sensor 102A₄ can include broad area filter 1002 that can be disposed over the filters 802D that can include filter portions P2. Note that the broad area filter 1002 can be for blocking light (λ_{VIS}) from the sensing areas S1 and S2 of imager 104. It is appreciated that the P2 filter portions of filter 802D can operate in a manner similar to filter 802B, as described herein.

FIG. 10E is a cross-sectional diagram illustrating an exemplary sensor 102A₅ in accordance with the invention. It is understood that only a portion of the sensor 102A₅ is illustrated in FIG. 10E. The sensor 102A₅ can include a narrowband filter 1006 and a glass cover 1004 that can be disposed over the filter 802E (which can include filter portions P2). It is appreciated that the P2 portions of filter 802E can operate in a manner similar to filter 802B, as described herein.

Narrowband filter 1006 can be implemented in embodiments in accordance with the invention as a dielectric stack filter that has particular spectral properties. For example in an embodiment in accordance with the invention, the dielectric stack filter can be formed as a dual-band filter. As such, narrowband filter 1006 (e.g., dielectric stack filter) can be designed to have one peak at λ₁ and another peak at λ₂. When light or illumination strikes narrowband filter 1006, the illumination at wavelengths other than the wavelengths of λ₁ and λ₂ are filtered out, or blocked, from passing through narrowband filter 1006. Thus, the illumination at visible wavelengths (avis) and at other wavelengths (λₙ) are filtered out in an embodiment in accordance with the invention, while the illumination at or near the wavelengths λ₁ and λ₂ transmit through the narrowband filter 1006. As such, only illumination at or near the wavelengths λ₁ and λ₂ pass through glass cover 1004. Thereafter, filter regions P2 of filter 802E transmit the illumination at wavelength λ₂ while blocking the light at wavelength λ₁. Consequently, the sensing areas S2 of imager 104 receive only the illumination at wavelength λ₂.

Within FIG. 10E, the sensing areas S1 of imager 104 receive illumination at wavelengths λ₁ and λ₂. In general, more illumination will reach sensing areas S1 than will reach sensing areas S2 covered by filter regions P2 of filter 802E. It is pointed out that image-processing software in sensor 102 can be used to separate the image generated in a first frame (corresponding to covered pixels S2) and the image generated in a second frame (corresponding to uncovered pixels S1). For example, sensor 102 may include an application-specific integrated circuit (ASIC), not shown, with pipeline processing to determine a difference image. MATLAB®, a product by The MathWorks, Inc. located in Natick, Mass., may be used to optimize the algorithm implemented in the ASIC.

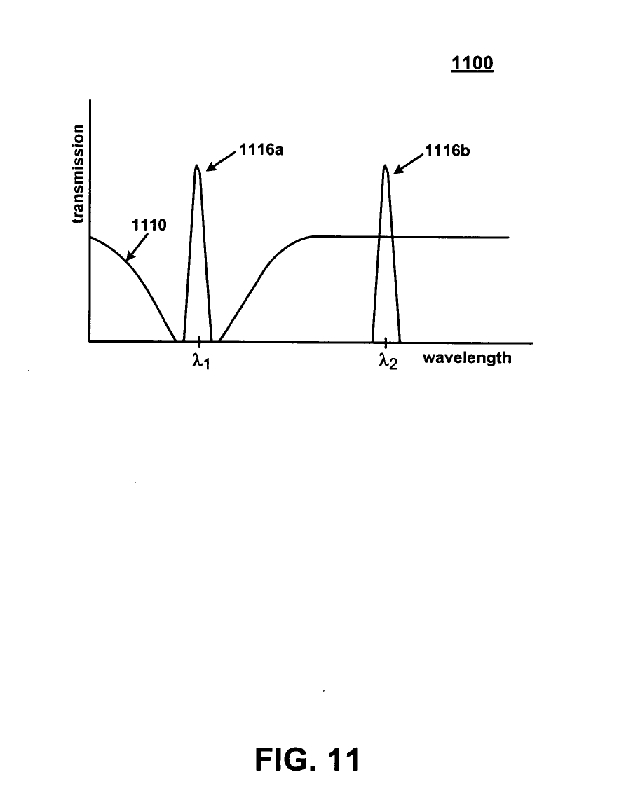

It is noted that the narrowband filter 1006 and the filter layer 802E can form a hybrid filter in an embodiment in accordance with the invention. FIG. 11 is a graph 1100 that depicts exemplary spectra for the filter layer 802E and the narrowband filter 1006 for embodiments in accordance with the invention. The narrowband filter 1006 can filter out all illumination except for the illumination at or near wavelengths λ₁ (spectral peak 1116a) and λ₂ (spectral peak 1116b). The filter layer 802E can block illumination at or near λ₁ (the minimum in spectrum 1110) while transmitting illumination at or near wavelength λ₂.

Within FIG. 10E, the sensor 102A₅ can be implemented to sit in a carrier (not shown) in embodiments in accordance with the invention. The glass cover 1004 can be utilized to protect imager 104 from damage and particle contamination (e.g., dust). As previously mentioned, the hybrid filter can include, but is not limited to, filter layer 802E, glass cover 1004, and narrowband filter 1006. The glass cover 1004 can be formed as, but is not limited to, a colored glass filter, and can be included as the substrate of the dielectric stack filter (e.g., narrowband filter 1006). The colored glass filter (e.g., 1004) can be designed to have certain spectral properties, and can be doped with pigments or dyes. Scholt Optical Glass Inc., a company located in Mainz, Germany, is one company that manufactures colored glass that can be used in colored glass filters (e.g., 1004).

In embodiments in accordance with the invention, the narrowband filter 1006 can be a dielectric stack filter that can be formed as a dual-band filter. It is understood that dielectric stack filters can include any combination of filter types. The desired spectral properties of the completed dielectric stack filter (e.g., 1006) determine which types of filters are included in the layers of the stack.

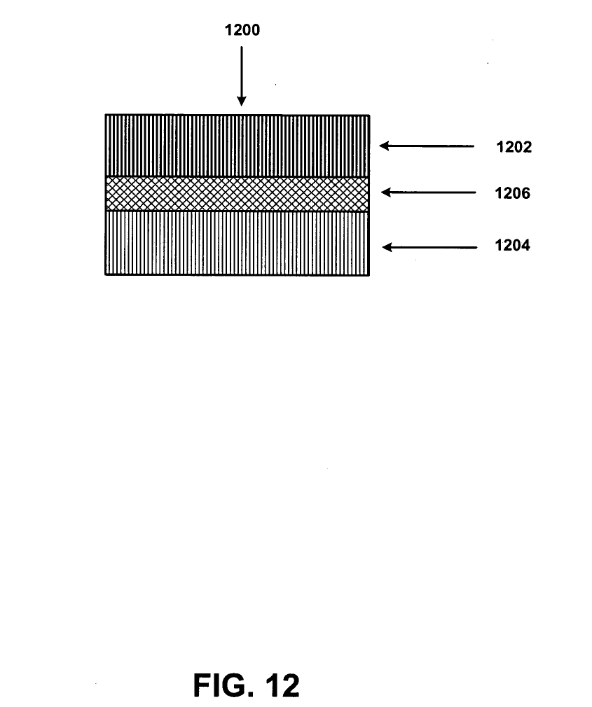

For example, a dual-band filter (e.g., 1006) can be fabricated by stacking three coupled-cavity resonators on top of each other, where each coupled-cavity resonator is formed with two Fabry-Perot resonators. FIG. 12 illustrates an exemplary Fabry-Perot (FP) resonator 1200 used in a method for fabricating a dual-band narrowband filter (e.g., 1006) in accordance with the invention. Resonator 1200 can include upper Distributed Bragg reflector (DBR) 1202 layer and lower DBR layer 1204, but is not limited to such. For example in embodiments in accordance with the invention, resonator 1200 can be built with reflectors that are not Distributed Bragg reflectors. The materials that form the DBR layers 1202 and 1204 can include N pairs of quarter-wavelength (mλ/4) thick low index material and quarter-wavelength (nλ/4) thick high index material, where the variable N is an integer number and the variables “m” and “n” are odd integer numbers. The wavelength can be defined as the wavelength of illumination in a layer, which is equal to the freespace wavelength divided by the layer index of refraction.

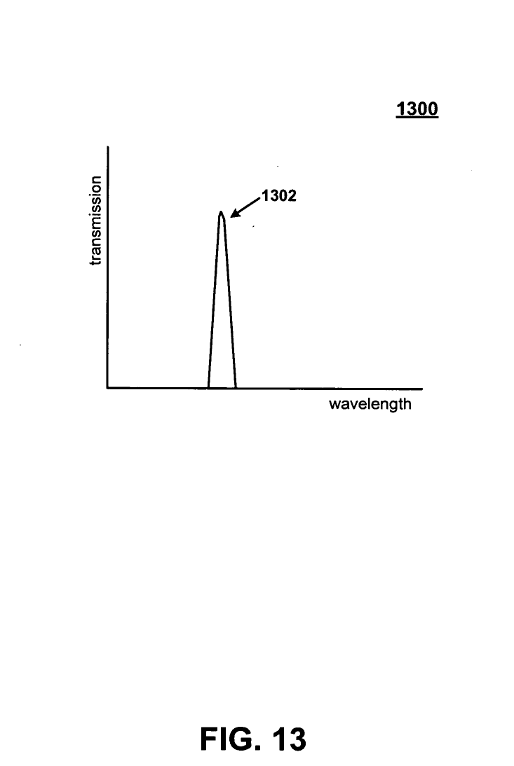

Cavity 1206 of resonator 1200 can separate the two DBR layers 1202 and 1204. Cavity 1206 can be configured as a half-wavelength (pλ/2) thick cavity, where “p” is an integer number. The thickness of cavity 1206 and the materials in DBR layers 1202 and 1204 can determine the transmission peak for FP resonator 1200. FIG. 13 is a graph 1300 that depicts exemplary spectrum for the Fabry-Perot resonator 1200 in accordance with the invention. As shown in graph 1300, the FP resonator 1200 has a single transmission peak 1302.

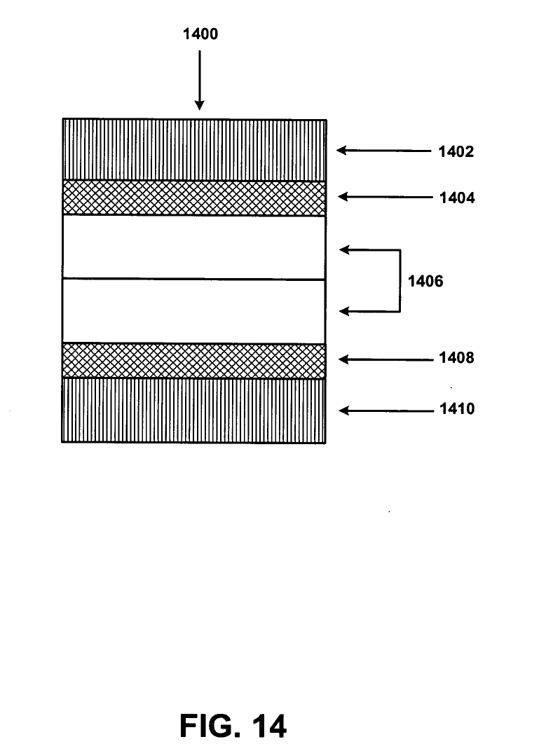

It is noted that a dual-band narrowband filter (e.g., 1006) can be fabricated with two FP resonators 1200 that are stacked together to create a coupled-cavity resonator. For example, FIG. 14 depicts a coupled-cavity resonator 1400 that can be used for fabricating a dual-band narrowband filter (e.g., 1006) in accordance with the invention. Coupled-cavity resonator 1400 can include, but is not limited to, an upper DBR layer 1402, cavity 1404, strong-coupling DBR 1406, cavity 1408, and lower DBR layer 1410. It is noted that the strong-coupling DBR 1406 of the coupled-cavity resonator 1400 can be formed when the lower DBR layer of top FP resonator (e.g., layer 1204) merges with an upper DBR layer of bottom FP resonator (e.g., layer 1202).

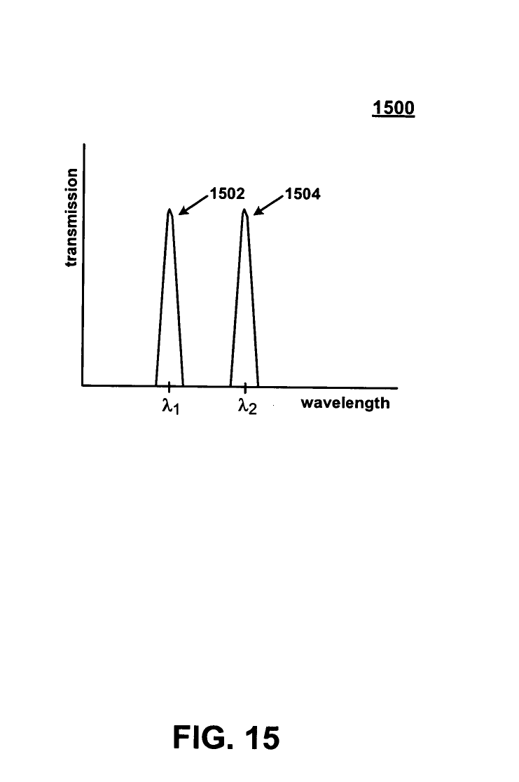

It is pointed out that by stacking two FP resonators together (e.g., 1400) splits single transmission peak 1302 of FIG. 13 into two peaks 1502 and 1504, as shown in graph 1500 of FIG. 15 that depicts exemplary spectrum for the coupled-cavity resonator 1400 in accordance with the invention. The number of pairs of quarter-wavelength thick index materials in strong-coupling DBR 1406 can determine the coupling strength between cavities 1404 and 1408. And the coupling strength between cavities 1404 and 1408 can control the spacing between peak 1502 and peak 1504 of graph 1500.

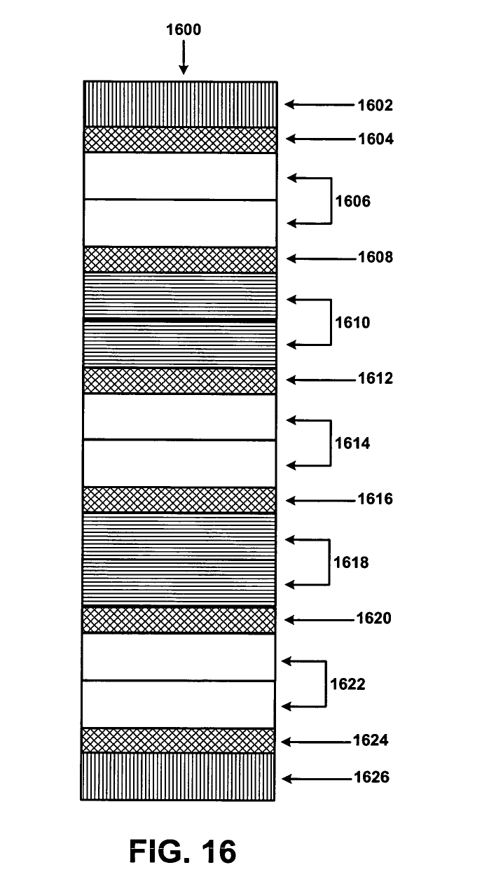

FIG. 16 illustrates a stack of three coupled-cavity resonators 1600 that form a dual-band narrowband filter (e.g., 1006) in accordance with the invention. The three coupled-cavity resonators 1600 can include, but is not limited to, an upper DBR layer 1602, cavity 1604, strong-coupling DBR 1606, cavity 1608, weak-coupling DBR 1610, cavity 1612, strong-coupling DBR 1614, cavity 1616, weak-coupling DBR 1618, cavity 1620, strong-coupling DBR 1622, cavity 1624, and lower DBR layer 1626.

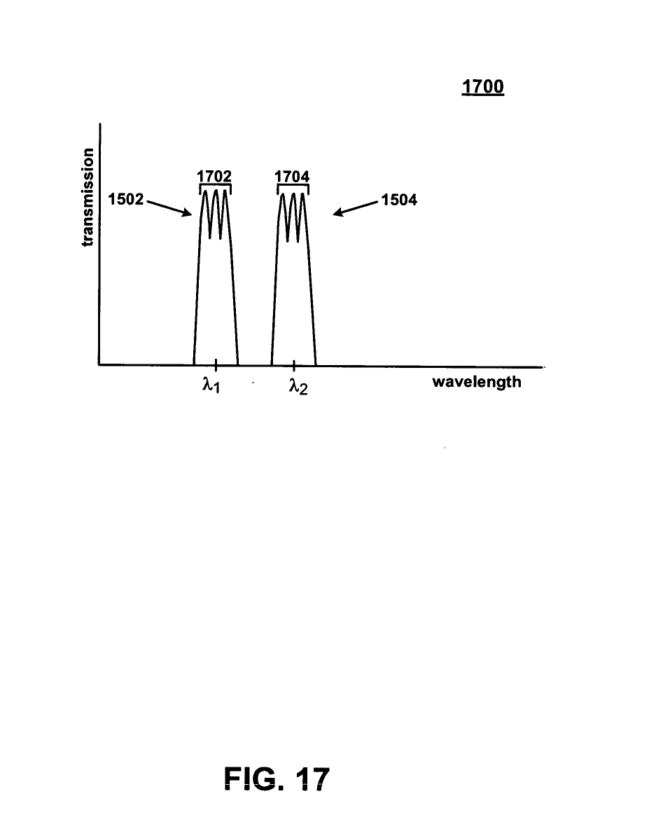

The stacked three coupled-cavity resonators 1600 together can split each of the two peaks 1502 and 1504 of FIG. 15 into a triplet of peaks 1702 and 1704, respectively, as shown in FIG. 17. FIG. 17 is a graph 1700 that depicts an exemplary spectrum for the three coupled-cavity resonators 1600 of FIG. 16 in accordance with the invention. Increasing the number of mirror pairs in the coupling DBRs 1610 and 1618 can reduce the coupling strength in weak-coupling DBRs 1610 and 1618. The reduced coupling strength can merge each triplet of peaks 1702 and 1704 into a single broad, fairly flat transmission band. Changing the number of pairs of quarter-wavelength thick index materials in weak-coupling DBRs 1610 and 1618 can alter the spacing within the triplet of peaks 1702 and 1704 of graph 1700.

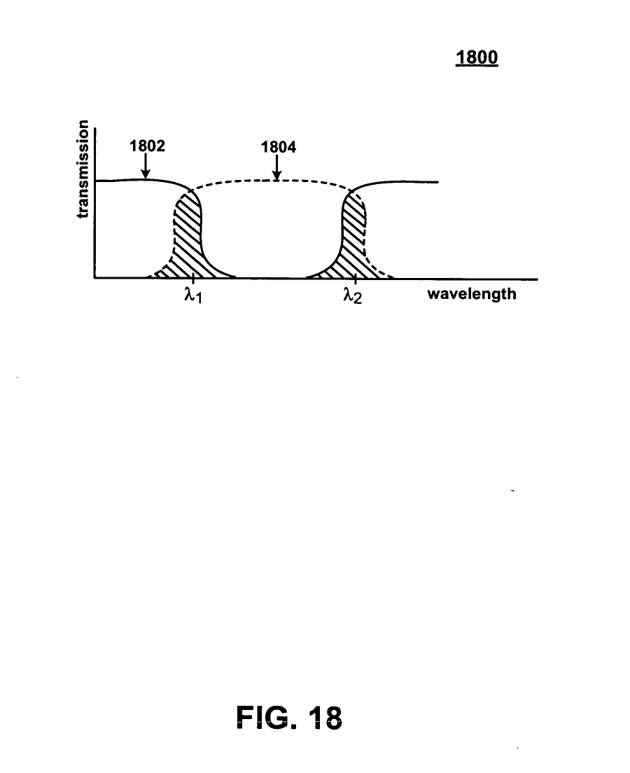

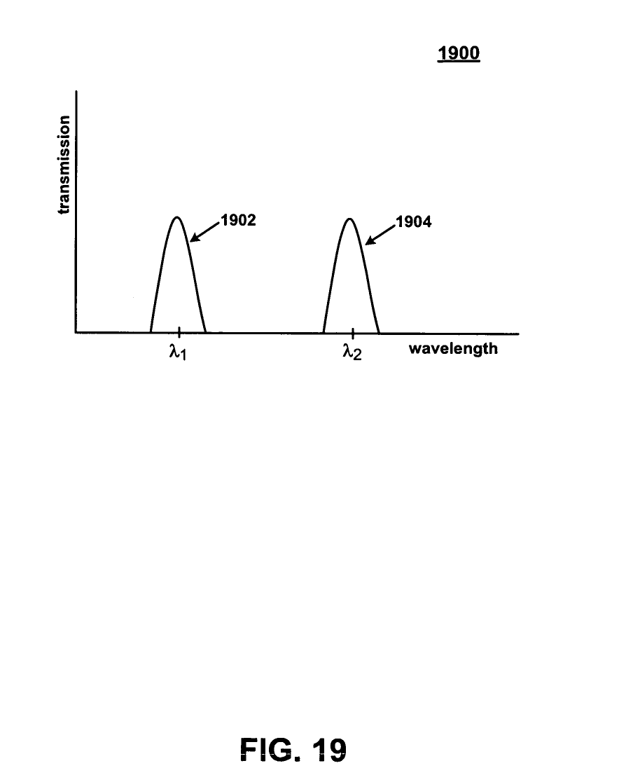

It is noted that there is another method for fabricating a dual-band narrowband filter (e.g., 1006) in accordance with the invention. For example, FIG. 18 is a graph 1800 illustrating exemplary filters 1802 and 1804 for embodiments in accordance with the invention. Specifically, a dual-band narrowband filter (e.g., 1006) can be fabricated by combining two filters 1802 and 1804. Band-blocking filter 1802 can filter out the illumination at wavelengths between the regions around wavelengths λ₁ and λ₂, while bandpass filter 1804 can transmit illumination near and between wavelengths λ₁ and λ₂. As such, the combination of filters 1802 and 1804 can transmit illumination in the hatched areas, while blocking illumination at all other wavelengths. FIG. 19 is a graph 1900 that depicts an exemplary spectrum for the dual-band narrowband filter in FIG. 18 in accordance with the invention. As can be seen, illumination transmits through the combined filters only at or near the wavelengths of interest, λ₁ (peak 1902) and λ₂ (peak 1904).

The foregoing descriptions of various specific embodiments in accordance with the invention have been presented for purposes of illustration and description. They are not intended to be exhaustive or to limit the invention to the precise forms disclosed, and obviously many modifications and variations are possible in light of the above teaching. The invention can be construed according to the Claims and their equivalents.

What is claimed is:

1. An orientation system comprising:
a target object including a retroreflective substrate;
an illumination source for outputting illumination; and
a sensor for receiving and for utilizing said illumination retroreflected from said retroreflective substrate of said target object to determine an orientation of said target object.

2. The orientation system of claim 1, wherein said retroreflective substrate is selected from the group consisting of a retroreflector, a substrate that substantially scatters illumination, any light-scattering material, any retroreflective material, a substrate that substantially retroreflects illumination, any reflective paint, any white-colored paint, any light-colored paint, any material that retroreflects illumination at a wavelength, and any material that scatters light at a wavelength.

3. The orientation system of claim 1, wherein said sensor comprises a filter for differentiating between said illumination retroreflected from said retroreflective substrate and a second illumination.

4. The orientation system of claim 1, wherein said retroreflective substrate is located at a depth below a surface of said target object.

5. The orientation system of claim 4, wherein said target object further comprises a second retroreflective substrate positioned differently than said retroreflective substrate.

6. The orientation system of claim 5, wherein said retroreflective substrate is located at a different depth than said second retroreflective substrate.

7. The orientation system of claim 1, wherein an intensity distribution associated with said retroreflective substrate is compared to a reference retroreflection by said sensor to determine said orientation of said target object.

8. The orientation system of claim 1, wherein a spacing between said retroreflective substrate and a second retroreflective substrate is compared to a reference retroreflection by said sensor to determine said orientation of said target object.

9. The orientation system of claim 1, wherein a visible length of said retroreflective substrate is compared to a reference retroreflection by said sensor to determine said orientation of said target object.

10. A target apparatus comprising:
a retroreflective substrate for retroreflecting illumination,
wherein said retroreflective substrate of said target apparatus can be utilized for determining an orientation of said target apparatus.

11. The target apparatus of claim 8, further comprising:
a second retroreflective substrate for retroreflecting illumination, wherein said retroreflective substrate and said second retroreflective substrate are positioned differently.

12. The target apparatus of claim 11, wherein said retroreflective substrate and said second retroreflective substrate are not parallel to each other.

13. The target apparatus of claim 11, wherein said retroreflective substrate and said second retroreflective substrate are located at different depths below a surface of said target apparatus.

14. The target apparatus of claim 8, wherein said retroreflective substrate can be utilized for determining said orientation of said target apparatus with respect to a three-dimensional space.

15. An orientation system comprising:
a target object;
a surface including a retroreflective substrate pattern;
an illumination source for outputting illumination; and
a sensor for receiving and for utilizing said illumination retroreflected from said retroreflective substrate pattern to determine an orientation of said target object.

16. The orientation system of claim 15, wherein said target object is selected from the group consisting of a gaming controller and a controller for a computing device.

17. The orientation system of claim 15, wherein said target object is located between said surface and said illumination source.

18. The orientation system of claim 15, wherein said sensor determines, based on a point of view of an imager of said sensor, the orientation of said target object based on what portion of said retroreflective substrate pattern is occluded by said target object.

19. The orientation system of claim 15, wherein said surface including said retroreflective substrate pattern is substantially planar.

20. The orientation system of claim 15, wherein said surface including said retroreflective substrate pattern is substantially non-planar.
